(19) United States
(12) Patent Application Publication
(10) Pub. No.: US 2022/0194169 A1
(43) Pub. Date: Jun. 23, 2022

(54) Door Assembly and HVAC System Having the Same

(71) Applicant: DENSO International America, Inc., Southfield, MI (US)

(72) Inventor: Mark ROTHENBERG, Farmington Hills, MI (US)

(21) Appl. No.: 17/124,715

(22) Filed: Dec. 17, 2020

(51) Int. Cl. B60H 1/00; B60H 1/34; B60S 1/54

(52) U.S. Cl. CPC B60H 1/00528; B60S 1/54; B60H 1/34; B60H 1/00285

(57) ABSTRACT

A door assembly for a heating, ventilation, and air conditioning (HVAC) system has a first door and a second door. The first door is fixed to a shaft. The second door is adjacent to the first door along a circumferential direction of the shaft and is fixed to a secondary shaft. The shaft and the secondary shaft are aligned coaxially and coupled with each other to be rotatable about a rotational axis independently of each other. The first door and the second door rotate about the rotational axis independently of each other in conjunction with the shaft and the secondary shaft. In an example, the HVAC system performs a driver-side concentration mode in which air flowing out of the HVAC system is concentrated to a driver seat of a vehicle.

### BACKGROUND

The present disclosure relates to a door assembly for a heating, ventilation, and air conditioning (HVAC) system and the HVAC system having the door assembly.

### SUMMARY

Current vehicle heating, ventilation, and air conditioning (HVAC) cases are suitable for their intended use, but are subject to improvement. For example, some vehicle HVAC cases provide concentrated airflow to a specific area, e.g., a driver seat of the vehicle, while other HVAC cases do not. HVAC cases that provide concentrated airflow to the specific area currently require different types of air distribution doors. It would therefore be desirable to have an air distribution door design that can be used in applications that provide concentrated airflow to the specific area of the vehicle. The present disclosure advantageously addresses this need in the art, as well as numerous others as described in detail herein.

In an example, a door assembly for a heating, ventilation, and air conditioning (HVAC) system has a first door and a second door. The first door is fixed to a shaft. The second door is adjacent to the first door along a circumferential direction of the shaft and is fixed to a secondary shaft. The shaft and the secondary shaft are aligned coaxially and coupled with each other to be rotatable about a rotational axis independently of each other. The first door and the second door rotate about the rotational axis independently of each other in conjunction with the shaft and the secondary shaft.

In an example, a heating, ventilation, and air conditioning (HVAC) system has a door assembly and a controller. The door assembly includes a first door fixed to a shaft and a second door adjacent to the first door along a circumferential direction of the shaft and fixed to a secondary shaft. The controller controls the shaft and the secondary shaft separately. The shaft and the secondary shaft are aligned coaxially and coupled with each other to be rotatable about a rotational axis independently of each other. The first door and the second door rotate about the rotational axis independently of each other in conjunction with the shaft and the secondary shaft.

Further areas of applicability of the present disclosure will become apparent from the detailed description, the claims and the drawings. The detailed description and specific examples are intended for purpose of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram showing a vehicle having a heating, ventilation, and air conditioning (HVAC) system;

FIG. 2 is a schematic diagram showing a vehicle cabin of the vehicle;

FIG. 3 Is a schematic diagram showing the HVAC system;

FIG. 4 is a perspective view of a door assembly for the HVAC system;

FIG. 5 is a perspective view of a door member for the door assembly;

FIG. 6 is a side view of the door member shown in FIG. 5;

FIG. 7 is a perspective view of the door assembly, in a defrost mode, housing the door member shown in FIG. 5;

FIG. 8 is a perspective view of the door assembly, in a face mode, housing the door member shown in FIG. 5;

FIG. 9 is a perspective view of a door member for the door assembly;

FIG. 10 is a side view of the door member shown in FIG. 9;

FIG. 11 is a cross-sectional view of the door member taken along a line XI-XI perpendicular to a rotational axis of the door member shown in FIG. 9;

FIG. 12 is a perspective view of the door assembly, in a normal face mode, housing the door member shown in FIG. 9;

FIG. 13 is a cross-sectional view that is taken along a line XIII-XIII perpendicular to the rotational axis of the door member and that shows the door assembly, in the normal face mode, shown in FIG. 12;

FIG. 14 is a perspective view of the door member, in a driver-side concentration mode;

FIG. 15 is a perspective view of the door assembly, in the driver-side concentration mode, housing the door member shown in FIG. 14; and

FIG. 16 is a cross-sectional view that is taken along a line XVI-XVI perpendicular to the rotational axis of the door member and that shows the door assembly, in the driver-side concentration mode, shown in FIG. 15.

In the drawings, reference numbers may be reused to identify similar and/or identical elements.

### DETAILED DESCRIPTION

Various heating, ventilation, and air conditioning (HVAC) systems are designed to control flows of air flowing into a vehicle cabin. Such HVAC systems have a plurality of air openings that discharge air from the HVAC systems to a vehicle cabin. The HVAC systems further have a plurality of doors that open and close the air openings selectively to discharge the air from selected air outlets. For example, when only a driver is in the vehicle cabin, the HVAC systems may open driver-side air opening and close other air openings to perform a driver-side concentration mode in which the HVAC systems discharge air from driver-side air openings mainly so that airflows flowing out of the HVAC systems are concentrated to the driver. The driver-side concentration mode contributes to energy saving by shutting air openings other than the driver-side air openings when no passenger other than the driver is present in the vehicle cabin.

As one example, an HVAC system has a case including a driver face opening, a passenger face opening, and a defroster opening. The HVAC system further has two doors located in the passenger face opening and the defroster opening respectively. In the driver-side concentration mode, the HVAC system operates the two doors to close the passenger face opening and the defroster opening respectively so that air in the HVAC system flows out from the driver face opening mainly.

As another example, an HVAC system has a single barrel door instead of the above-described two doors. By employing the barrel door, a quantity of doors can be reduced. Reducing the quantity of doors results in saving manufacturing cost. In addition, a control system for the single barrel door may be simple as compared to a control system that controls a plurality of doors separately. However, conventional barrel doors do not open and close a driver face opening and a passenger face opening separately. Specifically, the conventional barrel doors, in a face mode, open all face openings (e.g., the driver face opening and the passenger face opening) while closing a defroster opening. Alternatively, the conventional barrel doors, in a defrost mode, close all of the face openings while opening the defroster opening. That is, according to the HVAC system having the conventional barrel door, the driver-side concentration mode may not be performed.

The present application addresses the above-described issues and is directed to a unique and innovative door assembly for HVAC systems and an HVAC system having the door assembly.

Example embodiments will now be described with reference to the accompanying drawings.

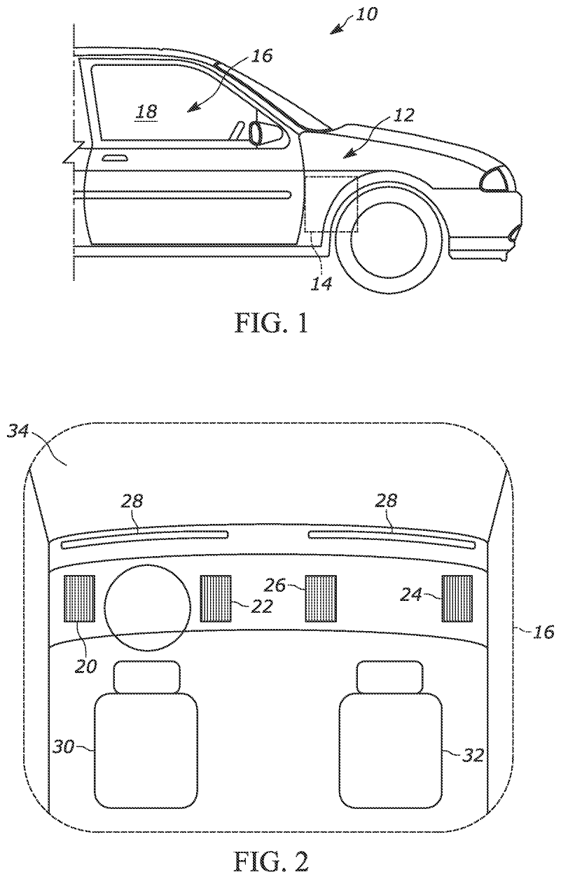

Referring to FIG. 1, a vehicle 10 is illustrated. The vehicle 10 includes an engine compartment generally indicated at 12. The vehicle 10 also includes a vehicle cabin 16. The vehicle cabin 16 defines an interior space 18 within the vehicle cabin 16. A heating, ventilation, and air conditioning (HVAC) unit 14 heats and/or cools air within the interior space 18 of the vehicle cabin 16 in a known manner. The HVAC unit 14 is arranged to achieve desired distribution of air to various ducts and outlets that discharge the air into the vehicle cabin 16. For example, the HVAC unit 14 may be included within the engine compartment 12 as schematically illustrated in FIG. 1. For another example, the HVAC unit 14 may be located inside an instrument panel of the vehicle 10 so that the HVAC unit 14 is at least partially inside the vehicle cabin 16.

FIG. 2 shows the interior space 18 of the vehicle cabin 16. The HVAC unit 14 discharges air into the interior space 18 from various air outlets. The air outlets include a driver side outlet 20, a driver center outlet 22, a passenger side outlet 24, a passenger center outlet 26, and defroster outlets 28. The driver side outlet 20 and the driver center outlet 22 discharge air toward a driver seat 30. The passenger side outlet 24 and the passenger center outlet 26 discharge air toward a passenger seat 32. The defroster outlets 28 discharges air toward a windshield 34.

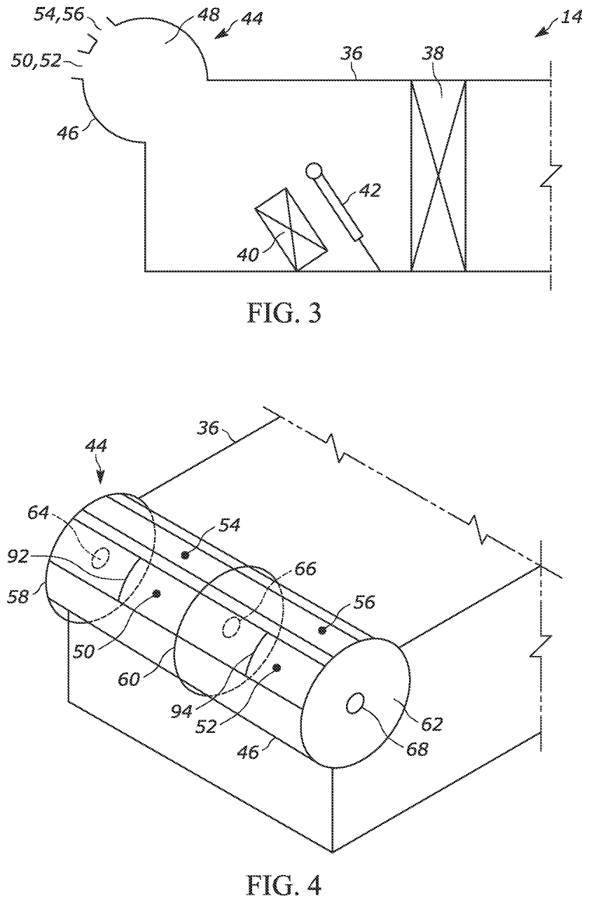

Referring to FIG. 3, the HVAC unit 14 is illustrated. The HVAC unit 14 has a case 36 in which air flows along a flow direction of air. A temperature of the air is adjusted in a known manner using a first heat exchanger 38, a second heat exchanger 40, and a door 42 located in the case 36. The first heat exchanger 38 may be an evaporator. The first heat exchanger 38 cools air flowing there through and discharges a cool air. The second heat exchanger 40 may be a heating heat exchanger or a heater core. The second heat exchanger 40 is located downstream of the first heat exchanger 38 along the flow direction of air. The second heat exchanger 40 takes in the cool air flowing from the first heat exchanger 38, heats the cool air, and discharges a warm air. The door 42 is located between the first heat exchanger 38 and the second heat exchanger 40 along the flow direction of air and changes an amount of the cool air flowing into the second heat exchanger 40.

A door assembly 44 which will be described later is attached to the case 36 at a most downstream end of the case 36 along the flow direction of air. The door assembly 44 defines a distribution chamber 48 therein. When the door 42 allows the air to flow into the second heat exchanger 40, the cool air from the first heat exchanger 38 and the warm air from the second heat exchanger 40 are mixed and flow into the distribution chamber 48. When the door 42 shuts off a flow of the air flowing into the second heat exchanger 40, the cool air from the first heat exchanger 38, only, may flow into the distribution chamber 48.

The door assembly 44 has a plurality of air openings, e.g., a driver face opening 50, a passenger face opening 52 and defroster openings 54 and 56. The door assembly 44 distributes the air to the vehicle cabin 16 from the air openings. Air flowing out of the driver face opening 50 flows toward a face of a driver at the driver seat 30 via the driver side outlet 20 and the driver center outlet 22. Air flowing out of the passenger face opening 52 flows toward a face of a passenger at the passenger seat 32 via the passenger side outlet 24 and the passenger center outlet 26. Air flowing out of the defroster openings 54 and 56 flows toward the windshield 34 via the defroster outlets 28.

Referring to FIG. 4, the door assembly 44 is illustrated. The door assembly 44 is a barrel door assembly. The door assembly 44 has a columnar shape. The door assembly 44 has a tubular case 46. The tubular case 46 has the driver face opening 50, the passenger face opening 52 and the defroster openings 54 and 56.

The tubular case 46 is provided with a first bearing 58, a second bearing 60, and a third bearing 62 arranged side by side along an axial direction of the tubular case 46. The second bearing 60 is located between the first bearing 58 and the third bearing 62 along the axial direction. Each of the first bearing 58, the second bearing 60 and the third bearing 62 has a discoid shape and is located to be perpendicular to the axial direction. The first bearing 58 has a first shaft hole 64 at a center thereof. The second bearing 60 has a second shaft hole 66 at a center thereon. The third bearing 62 has a third shaft hole 68 at a center thereof. The first bearing 58, the second bearing 60 and the third bearing 62 support a door member rotatably as described later so that the door assembly 44 houses the door member rotatably.

The driver face opening 50 is located between the first bearing 58 and the second bearing 60 along the axial direction. The passenger face opening 52 is located between the second bearing 60 and the third bearing 62 along the axial direction and is adjacent to the driver face opening 50 along the axial direction. The defroster opening 54 is located between the first bearing 58 and the second bearing 60 along the axial direction and is adjacent to the driver face opening 50 along a circumferential direction of the tubular case 46. The defroster opening 56 is located between the second bearing 60 and the third bearing 62 along the axial direction. The defroster opening 56 is adjacent to the passenger face opening 52 along the circumferential direction and is adjacent to the defroster opening 54 along the axial direction.

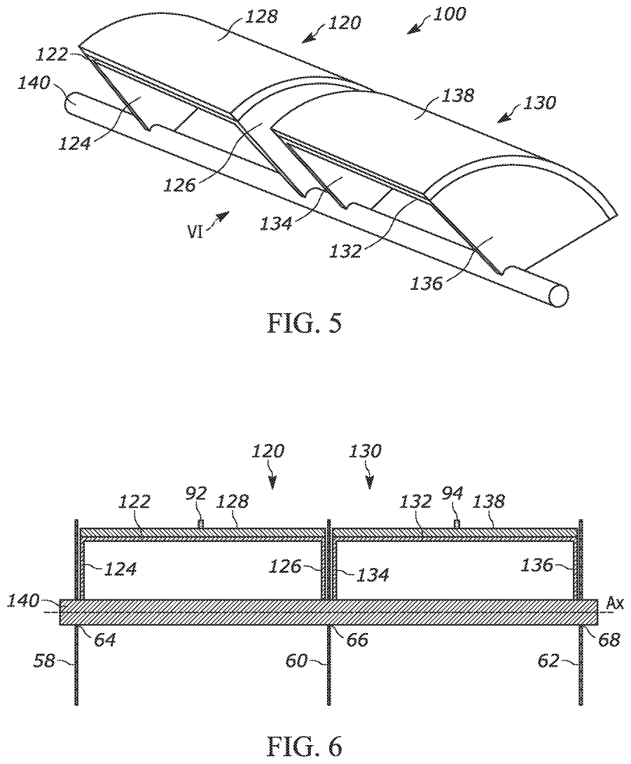

Referring to FIG. 5 and FIG. 6, a door member 100 is illustrated. The door member 100 is a known barrel door.

The door member 100 has a first door 120 and a second door 130 connected to a shaft 140. The first door 120 and the second door 130 are adjacent to each other along a rotational axis Ax of the shaft 140. The first door 120 is coupled with the shaft 140 by way of a pair of connector plates 124 and 126. The second door 130 is coupled with the shaft 140 by way of a pair of connector plates 134 and 136. When the shaft 140 rotates about the rotational axis Ax, the first door 120 and the second door 130 rotate together in conjunction with the shaft 140. The first door 120 and the second door 130 may not rotate separately.

The tubular case 46 supports the shaft 140 and houses the first door 120 and the second door 130 rotatably. The shaft 140 extends along the tubular case 46 and located coaxially with the tubular case 46. Accordingly, the axial direction of the tubular case 46 is parallel to the rotational axis Ax.

The first door 120 has a base plate 122 curved along the circumferential direction and connecting the pair of connector plates 124 and 126. A sealing member 128 is attached to an outer surface of the base plate 122. The second door 130 has a base plate 132 curved along the circumferential direction and connecting the pair of connector plates 134 and 136. A sealing member 138 is attached to an outer surface of the base plate 132. As an example, the shaft 140, the base plate 122, the pair of connector plates 124 and 126, the base plate 132 and the pair of connector plates 134 and 136 are made of the same material and molded all together at the same time.

The shaft 140 passes through the first shaft hole 64, the second shaft hole 66 and the third shaft hole 68. The first door 120 is located between the first bearing 58 and the second bearing 60 along the rotational axis Ax. The second door 130 is located between the second bearing 60 and the third bearing 62 along the rotational axis Ax. An actuator rotates the shaft 140. A controller operates the actuator.

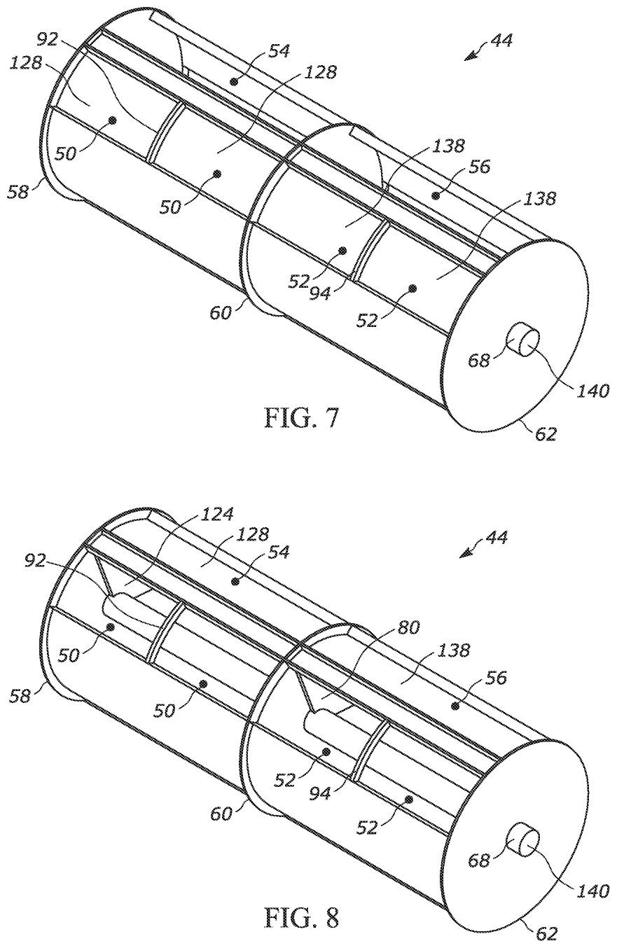

Referring to FIG. 7, the door assembly 44 in a defrost mode is illustrated. In the defrost mode, the controller rotates the door member 100 to close the driver face opening 50 and the passenger face opening 52 and open the defroster openings 54 and 56. The sealing member 128 seals the driver face opening 50. The sealing member 138 seals the passenger face opening 52. Accordingly, the air in the distribution chamber 48 is discharged from the defroster openings 54 and 56 and flows toward the windshield 34 through the defroster outlets 28.

Referring to FIG. 8, the door assembly 44 in a normal face mode is illustrated. In the normal face mode, the controller rotates the door member 100 to open the driver face opening 50 and the passenger face opening 52 and close the defroster openings 54 and 56. The sealing member 128 seals the defroster opening 54. The sealing member 138 seals the defroster opening 56. Accordingly, the air in the distribution chamber 48 is discharged from the driver face opening 50 and the passenger face opening 52. Since both of the first door 120 and the second door 130 are fixed to the shaft 140, the second door 130 opens the passenger face opening 52 inevitably when the first door 120 opens the driver face opening 50.

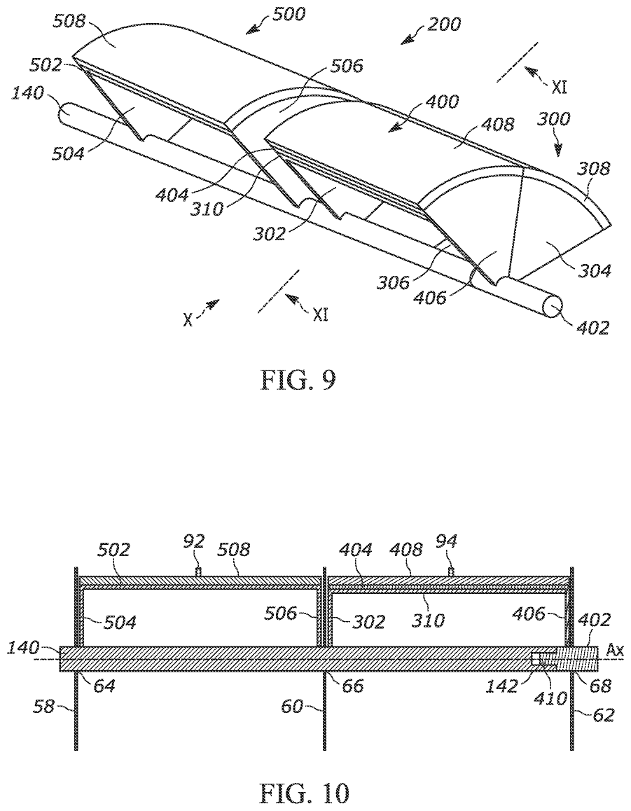

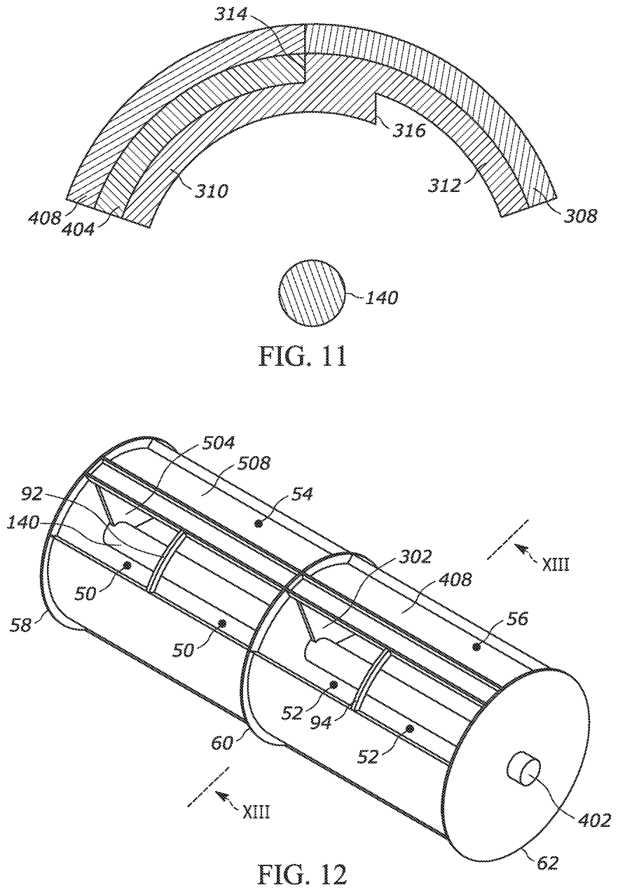

With reference to FIG. 9, FIG. 10 and FIG. 11, a door member 200 will be described hereafter. The door member 200 is a barrel door. The door member 200 has a first door 300, a second door 400 and a third door 500.

The third door 500 has the same structure as the first door 120 of the door member 100. The third door 500 has a base plate 502 curved along the circumferential direction and connecting a pair of connector plates 504 and 506. The third door 500 is fixed to the shaft 140 by way of the pair of connector plates 504 and 506. A sealing member 508 is attached to an outer surface of the base plate 502.

As shown in FIG. 9, the first door 300 is fixed to the shaft 140 by way of a pair of connector plates, i.e., a first connector plate 302 and a second connector plate 304. The first connector plate 302 is directly fixed to the shaft 140. The second connector plate 304 is fixed to the shaft 140 via a tab 306. The tab 306 extends from the shaft 140 along a radial direction of the shaft 140. The tab 306 is a small plate in shape and located to be parallel with the rotational axis Ax. The tab 306 extends from the shaft 140 to the second connector plate 304 and connects the shaft 140 and the second connector plate 304. Accordingly, the first door 300 rotates together with the shaft 140 when the shaft 140 rotates. The first door 300 has a sealing member 308 attached to an outer surface of a second base plate 312.

The first connector plate 302 is misaligned from the second connector plate 304 along the circumferential direction. As an example, the first connector plate 302 and the second connector plate 304 do not overlap with each other when viewing in the axial direction.

The second door 400 is located adjacent to the first door 300 along the circumferential direction. The second door 400 is connected to the shaft 140 via a secondary shaft 402. The secondary shaft 402 is located coaxially with the shaft 140 and rotates about the rotational axis Ax. The shaft 140 and the secondary shaft 402 rotate independently of each other. Accordingly, the first door 300 and the second door 400 rotate about the rotational axis Ax separately from each other. As an example, different actuators may move the shaft 140 and the secondary shaft 402. A common controller may control the actuators. Alternatively, different controllers may control the actuators respectively.

The second door 400 has a sealing member 408 attached to an outer surface of a base plate 404. When the second door 400 is located to be in contact with the first door 300, the sealing member 308 and the sealing member 408 are connected seamlessly. In other words, when the second door 400 is located to be in contact with the first door 300, the sealing member 308 and the sealing member 408 are aligned to be flush.

As shown in FIG. 10, the first door 300 and the second door 400 are located between the second bearing 60 and the third bearing 62. The third door 500 is located between the first bearing 58 and the second bearing 60 along the axial direction. The shaft 140 passes through the first shaft hole 64 and the second shaft hole 66 so that the first bearing 58 and the second bearing 60 hold the shaft 140. The secondary shaft 402 passes through the third shaft hole 68 so that the third bearing 62 holds the secondary shaft 402.

The secondary shaft 402 is coupled with the shaft 140 rotatably and rotates about the rotational axis Ax independently. The shaft 140 and the secondary shaft 402 are coupled in a known manner. For example, the shaft 140 has a male portion at one end 142 along the axial direction and the secondary shaft 402 has a female portion at one end 410 along the axial direction. The male portion and the female portion fit each other and coupled to be rotatable with respect to each other. Alternatively, the shaft 140 has a female portion at the one end 142 and the secondary shaft 402 has a male portion at the one end 410.

The first door 300 has a base plate 310 connected to the shaft 140 via the first connector plate 302. The first door 300 is curved along the circumferential direction. The first connector plate 302 extends from the shaft 140 and perpendicular to the shaft 140. The first base plate 310 is perpendicular to the first connector plate 302 and parallel to the shaft 140. As an example, the shaft 140, the base plate 310, the pair of connector plate 302 and 304, and the tab 306 may be made of the same material and molded all together at the same time.

The second door 400 has the base plate 404 connected to the secondary shaft 402 via a connector plate 406. The base plate 404 is curved along the circumferential direction. The connector plate 406 extends from the secondary shaft 402 and perpendicular to the secondary shaft 402. The base plate 404 is perpendicular to the connector plate 406 and parallel with the secondary shaft 402. As an example, the secondary shaft 402, the base plate 404 and the connector plate 406 may be made of the same material and molded all together at the same time.

The second door 400 slides on the first door 300. Specifically, the base plate 404 of the second door 400 slides on the first base plate 310 of the first door 300.

As shown in FIG. 11, the first base plate 310 and the second base plate 312 are misaligned from each other along the radial direction. Specifically, the second base plate 312 is located on an outer side of the first base plate 310 along the radial direction. The first base plate 310 partially overlaps with the second base plate 312 along the circumferential direction. Accordingly, the first base plate 310 and the second base plate 312 form a step 314 on the outer side of the first base plate 310. The step 314 protrudes outward from the first base plate 310 along the radial direction. The first base plate 310 and the second base plate 312 may further form a step 316 on an inner side of the second base plate 312 along the radial direction. The step 316 extends inward from the second base plate 312 along the radial direction. However, the step 316 may not be necessarily formed. As an example, an inner surface of the first base plate 310 extends entirely along the second base plate 312.

As an example, the first base plate 310 and the second base plate 312 may be made of the same material and molded together at the same time. However, the first base plate 310 and the second base plate 312 may be made of different materials, formed separately, and coupled to be a single piece.

The step 314 serves as a stopper portion when the second door 400 comes in contact with the first door 300. Specifically, the base plate 404 abuts to the step 314 at an edge 412 of the second door 400 along the circumferential direction. When the base plate 404 abuts to the step 314, the first base plate 310 may entirely overlap with the base plate 404 of the second door 400. As an example, a length of an outer surface of the first base plate 310 along the circumferential direction may be equal to a length of an inner surface of the base plate 404 along the circumferential direction.

Returning to FIG. 9, when the second door 400 is in contact with the first door 300, the second connector plate 304 and the connector plate 406 are connected to each other seamlessly. In other words, when the second door 400 is in contact with the first door 300, the connector plate 406 and the second connector plate 304 form a flat surface.

The sealing member 308 of the first door 300 is attached to the outer surface of the second base plate 312. The sealing member 408 of the second door 400 is attached to the outer surface of the base plate 404. When the base plate 404 abuts to the step 314, the sealing member 308 and the sealing member 408 are connected seamlessly, i.e., the sealing member 308 and the sealing member 408 are aligned to be flush.

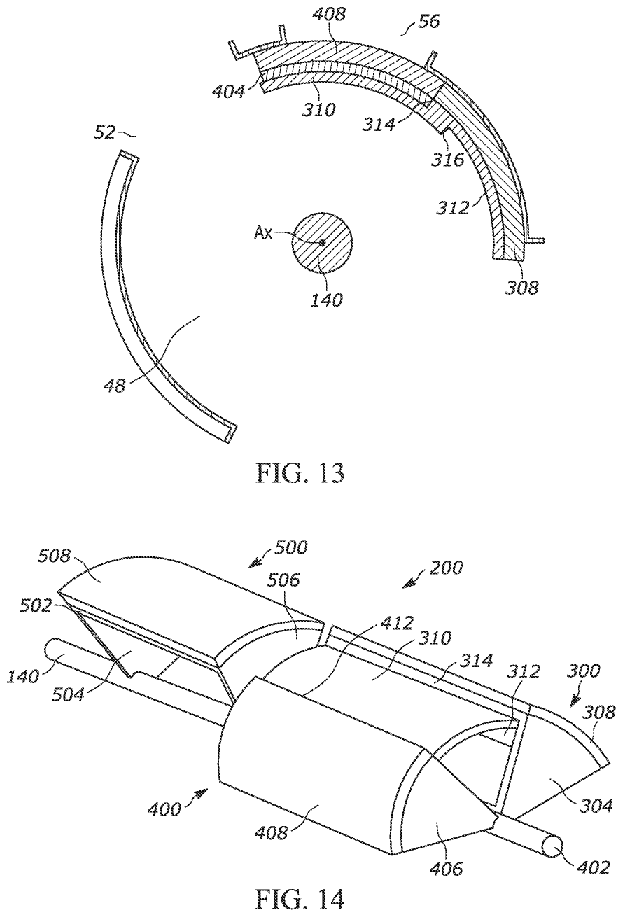

Referring to FIG. 12 and FIG. 13, the door assembly 44 in a normal face mode will be described.

In the normal face mode, the controller moves the door member 200 so that the driver face opening 50 and the passenger face opening 52 are open and the defroster openings 54 and 56 are closed. Accordingly, air in the distribution chamber 48 flows toward the driver seat 30 and the passenger seat 32. More specifically, the controller rotates the shaft 140 so that first door 300 and the third door 500 open passenger face opening 52 and the driver face opening 50 respectively, and rotates the secondary shaft 402 so that the second door 400 opens the passenger face opening 52.

As shown in FIG. 12, in the normal face mode, the sealing member 128 of the first door 120 seals the defroster opening 56 to shut off a flow of air flowing out of the defroster opening 56, and the sealing member 408 of the second door 400 seals the defroster opening 56 to shut off a flow of air flowing out of the defroster opening 56.

As shown in FIG. 13, the first base plate 310 of the first door 300 entirely overlaps with the defroster opening 56. The base plate 404 is located on the first base plate 310 and entirely overlaps with the defroster opening 56, therefore the sealing member 408 seals the defroster opening 56. The step 314 sets the location of the base plate 404 in the normal face mode. As an example, the base plate 404 abuts to the step 314 in the normal face mode. However, a gap may be formed between the base plate 404 and the step 314 along the circumferential direction as long as the base plate 404, i.e., the sealing member 408, overlaps with the defroster opening 56 entirely.

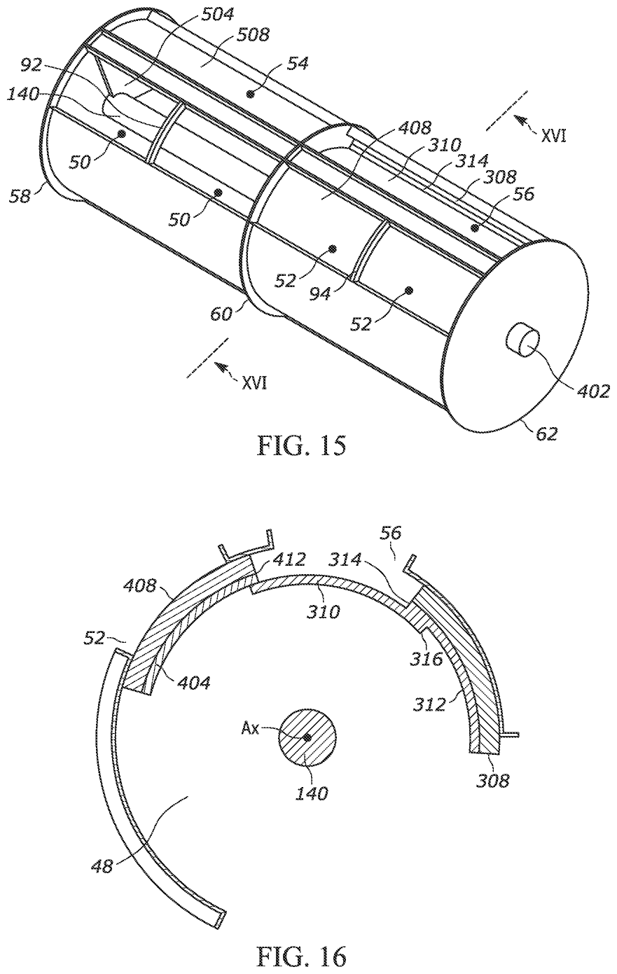

Referring to FIG. 14, FIG. 15 and FIG. 16, the door assembly 44 in the driver-side concentration mode will be described. In the driver-side concentration mode, the first door 300 and the third door 500 are at the same positions as in the normal face mode, and the second door 400 is located at a different position as compared to the normal face mode. Specifically, the controller rotates the shaft 140 so that (i) the first door 300 opens the passenger face opening 52 and closes the defroster opening 56 and (ii) the third door 500 opens the driver face opening 50 and closes the defroster opening 54, and rotates the secondary shaft so that the second door 400 closes the passenger face opening 52.

As shown in FIG. 14, in the driver-side concentration mode, the second door 400 is moved away from the second base plate 312 of the first door 300. In other words, the second door 400 is distanced from the second base plate 312 along the circumferential direction. The first base plate 310 of the first door 300 is located between the second base plate 312 and the second door 400 along the circumferential direction.

As shown in FIG. 15, the first base plate 310 overlaps with the defroster opening 56. The sealing member 408 of the second door 400 seals the passenger face opening 52.

As shown in FIG. 16, in the driver-side concentration mode, the base plate 404 of the second door 400 overlaps with the first base plate 310 of the first door 300 at the edge 412 of the second door 400. More specifically, an inner surface of the base plate 404 of the second door 400 is in contact with an outer surface of the first base plate 310 of the first door 300 at the edge 412 of the base plate 404. As such, no clearance is formed between the first base plate 310 and the base plate 404. In addition, since the first base plate 310 and the step 314 are molded all together to be a single piece, no clearance is formed between the first base plate 310 and the second base plate 312. Accordingly, the first door 300 and the second door 400 prevent air in the distribution chamber 48 from flowing out through the passenger face opening 52 and the defroster opening 56. Thus, in the driver-side concentration mode, air in the distribution chamber 48 flows out of the door assembly 44 from the driver face opening 50, only.

However, as another example, the second door 400 may be moved away from the first door 300 to form a gap between the first base plate 310 and the base plate 404 so that some air flows out through the gap. The second door 400 may be moved to change a distance between the first door 300 and the second door 400. In other words, the gap between the first door 300 and the second door 400 may be changed to obtain a required volume of air flowing from the passenger face outlet 54 toward the passenger seat 32.

Thus, the door member 200 can open and close the driver face opening 50 and the passenger face opening 52 selectively by moving the first door 300 and the second door 400 separately. Therefore, the driver-side concentration mode can be performed with the door assembly 44.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A door assembly for a heating, ventilation, air conditioning (HVAC) system, comprising:
a first door fixed to a shaft; and
a second door adjacent to the first door along a circumferential direction of the shaft and fixed to a secondary shaft, wherein
the shaft and the secondary shaft are aligned coaxially and coupled with each other to be rotatable about a rotational axis independently of each other, and
the first door and the second door rotate about the rotational axis independently of each other in conjunction with the shaft and the secondary shaft.

2. The door assembly of claim 1, wherein
the first door has a first base plate located parallel to the rotational axis,
the second door has a base plate located parallel to the rotational axis, and
the base plate of the second door is slidable on the first base plate of the first door.

3. The door assembly of claim 2, wherein
the first door has a stopper portion protruding outward from the first base plate along a radial direction of the shaft, and
the second door has an edge along the circumferential direction which comes in contact with the stopper portion.

4. The door assembly of claim 3, wherein
the first door has a second base plate located parallel to the rotational axis,
the second base plate is located on an outer side of the first base plate along the radial direction and connected to the first base plate, and
the stopper portion is a step formed by the first base plate and the second base plate on the outer side of the first base plate.

5. The door assembly of claim 4, wherein
the second door is located on the outer side of the first base plate along the radial direction, and
when the edge of the second door abuts to the stopper portion, an outer surface of the second base plate of the first door and an outer surface of the door base of the second door are connected seamlessly.

6. The door assembly of claim 4, wherein
the first base plate and the second base plate are molded together to be a single piece.

7. The door assembly of claim 4, wherein
each of the first base plate and the second base plate of the first door is curved along the circumferential direction, and
a sealing member is attached to an outer surface of the second base plate.

8. The door assembly of claim 1, wherein
the second door has a base plate that is located parallel to the rotational axis and that is curved along the circumferential direction, and
a sealing member is attached to an outer surface of the base plate of the second door.

9. The door assembly of claim 1, the door assembly further comprising:
a third door fixed to the shaft and adjacent to the first door along the rotational axis, wherein
the first door and the third door rotate together in conjunction with the shaft, and
the second door rotates separately from the first door and the third door in conjunction with the secondary shaft.

10. A heating, ventilation, air conditioning (HVAC) system, the HVAC system comprising:
a door assembly having:
a first door fixed to a shaft; and
a second door adjacent to the first door along a circumferential direction of the shaft and fixed to a secondary shaft; and
a controller controlling the shaft and the secondary shaft separately, wherein
the shaft and the secondary shaft are aligned coaxially and coupled with each other to be rotatable about a rotational axis independently of each other, and
the first door and the second door rotate about the rotational axis independently of each other in conjunction with the shaft and the secondary shaft.

11. The HVAC system of claim 10, wherein
the door assembly has a tubular case,
the tubular case supports the shaft and the secondary shaft and houses the first door and the second door rotatably,
the first door and the second door are adjacent to each other along the circumferential direction,
the tubular case has a first opening and a second opening adjacent to each other along the circumferential direction,
the controller is configured to close the second opening by the second door while closing the first opening by the first door.

12. The HVAC system of claim 11, wherein
the door assembly has a third door in the tubular case,
the third door is fixed to the shaft, is adjacent to the first door along the rotational axis, and rotates together with the first door in conjunction with the shaft,
the tubular case further has:
a third opening adjacent to the first opening along the rotational axis; and
a fourth opening adjacent to the third opening along the circumferential direction and adjacent to the second opening along the rotational axis,
the controller moves the third door to open and close the third opening and the fourth opening selectively,
the controller is configured to open the fourth opening while closing the first, second and third openings by the first, second and third doors respectively.

13. The HVAC system of claim 12, wherein
the HVAC system is for a vehicle,
the first opening and the third openings are defroster openings that discharge air toward a windshield of the vehicle,
the second opening is a passenger face opening that discharges air to a passenger seat of the vehicle,
the fourth opening is a driver face opening that discharges air to a driver seat of the vehicle, and
the controller is configured to perform a driver-side concentration mode, in which airflow flowing out of the door assembly is concentrated to the driver seat, by opening the driver face opening while closing the defroster openings and the passenger face opening.

14. The door assembly of claim 10, wherein
the first door has a first base plate located parallel to the rotational axis,
the second door has a base plate located parallel to the rotational axis, and
the base plate of the second door is slidable on the first base plate of the first door.

15. The door assembly of claim 14, wherein
the first door has a stopper portion protruding outward from the first base plate along a radial direction of the shaft, and
the second door has an edge along the circumferential direction which comes in contact with the stopper portion.

16. The door assembly of claim 15, wherein
the first door has a second base plate located parallel to the rotational axis,
the second base plate is located on an outer side of the first base plate along the radial direction and connected to the first base plate, and
the stopper portion is a step formed by the first base plate and the second base plate on the outer side of the first base plate.

17. The door assembly of claim 16, wherein
the second door is located on the outer side of the first base plate along the radial direction, and
when the edge of the second door abuts to the stopper portion, an outer surface of the second base plate of the first door and an outer surface of the door base of the second door are connected seamlessly.

18. The door assembly of claim 16, wherein
the first base plate and the second base plate are molded together to be a single piece.

19. The door assembly of claim 16, wherein
each of the first base plate and the second base plate of the first door is curved along the circumferential direction, and
a sealing member is attached to an outer surface of the second base plate.

20. The door assembly of claim 10, wherein
the second door has a base plate that is located parallel to the rotational axis and that is curved along the circumferential direction, and
a sealing member is attached to an outer surface of the base plate of the second door.
